(19) United States
(12) Patent Application Publication
(10) Pub. No.: US 2003/0182173 A1
(43) Pub. Date: Sep. 25, 2003

(54) System and method for improved capacity planning and deployment

(75) Inventors: Daniel D'Elena, West Milford, NJ (US); Steven Edward Heise, Glen Ellyn, IL (US); Anthony Edward Martinez, Spicewood, TX (US); Ronald James Salpietra, Huntersville, NC (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/105,113

(22) Filed: Mar. 21, 2002

(51) Int. Cl. G06F 17/60

(52) U.S. Cl. 705/9

(57) ABSTRACT

A system and method for improved capacity planning and deployment is presented. Codified skills are used to generate job roles and employee skill profiles. Job roles include codified skills corresponding to the type of skills an employee needs to effectively perform a job assignment corresponding to his job role. An employee skill profile includes codified skills corresponding to the employees' capabilities. Job roles and employee skill profiles may be compared in various ways that allows an organization to effectively hire, develop, and manage employees.

### BACKGROUND OF THE INVENTION

1. Technical Field

The present invention relates in general to a system and method for improved capacity planning and deployment. More particularly, the present invention relates to a system and method for using codified skills in employee profiles and job roles to link skill development with resource management.

2. Description of the Related Art

Managers in modern business organizations have increasingly complex roles to perform in managing the various facets of the business organization. While managers differ greatly in the objectives and goals of their respective departments or areas, a key element that most managers deal with are the employees in their department or area and their efforts to maintain a competitive knowledge base.

In evolving industries, a competitive employee knowledge base is essential to ensure an organizations' success. Especially in rapidly moving industries, such as the technology industry, employees must frequently update their skills or the organization becomes uncompetitive and the employee becomes less marketable in the workforce. A challenge found with updating employee skills is determining the appropriate training for each employee. Employees with the same job title, such as “Java application programmer” may have different skills based upon past work assignments or training. By having each employee attend a class based upon a job title may waste resource time and money. Using the example described above, having every Java application programmer attend a “Java Swing” class may be unnecessary because some Java application programmers may have acquired a Java Swing skill from past work assignments or training.

Additionally, managers may find it challenging to hire employees from a different company due to non-standard job titles throughout their particular industry. For example, in “Company A” a project manager may possess extensive experience in design, leadership, and financial management. However, a project manager in “Company B” may only have a few years of work experience with limited knowledge in leadership.

An even more difficult challenge arises when a manager attempts to hire a person from a different industry (cross-industry). This is occasionally performed for high-level management positions (i.e. CEO) to bring about a different viewpoint at a company. Cross-industry hiring is rarely done at mid-level and low-level positions because the manager may not understand the skills of a cross-industry job candidate.

For example, a business consultant in the banking industry may have the skills required to perform a job in the manufacturing industry, such as return on investment analysis. However, the business consultant may not be considered for a job in the manufacturing industry because the hiring manager may not understand the unique terminology of the banking industry regarding job descriptions and responsibilities.

Furthermore, organizations may forgo business opportunities due to their inability to quantify their workforce skill set. For example, an organization may have 200 employees with a “Java Application Programmer” title. The organization may not bid on an opportunity that requires 300 Java application programmers because the organization assumes they do not have enough resources. However, the organization may have 100 “Java User Interface Designer” employees that may require minimal training to obtain the skills required to perform Java application programmer responsibilities. A challenge found is identifying the workforce skill set with enough detail to accurately assess business opportunities.

Finally, organizations may have challenges using a structured format for employee performance reviews. One employee's responsibilities and performance may be very specific (i.e. “mastered algorithm design”) while a second employee's responsibilities and performance may be generalized (i.e. knowledgeable in programming”). Performance review formats may also cover skills in which an employee's job assignment does not require. For example, an employee may have an individual assignment in which he does not associate with other employees and yet he may be assessed on “teamwork”.

What is needed, therefore, is a way to predictably describe and analyze employee skill sets for effective hiring, developing, and employee management.

### SUMMARY

It has been discovered that a job role structure and process provides an organization the ability to associate employee skill development with employee resource management which allows the organization to effectively hire, develop, and manage employees.

The job role structure and process codifies skills and uses the codified skills to generate job roles and employee skill profiles. Codified skills may be segmented into two categories that are core skills and functional skills. Core skills are profession specific skills that are acquired over time and functional skills define a job role in more detail and may be acquired in a shorter timeframe, such as attending a class. For example, an information technology (IT) profession core skill may be “teamwork” and a functional skill may be “algorithm design”.

The job role structure provides a common structure for job definition and the skills they require. A job role structure defines an organizations' resources in terms of recognized market standards and nomenclature. For example, a business consultant in the banking industry requires a knowledge base relating to banking systems, banking industry issues, and banking regulation to effectively serve his customers. Building the job role in terms of these standards and nomenclature provides a common, industry-wide means of defining employees and their skills.

Job roles are created by assessing business opportunities and business solutions (i.e. business offerings). Relevant codified skills are selected from a database of codified skills and associated with corresponding job roles. Codified skills are also used to generate employee skill profiles. An employee skill profile includes codified skills corresponding to the employee's capabilities. The employee's skill profile may include skills that are not applicable to his current job assignment. For example, a Java application programmer may have C++ experience from past work assignments or from other means of education (books, seminars, etc.). The employee's skill profile includes C++ related skills even though the employee is currently assigned to a Java application programmer job assignment.

Furthermore, the job role structure provides the information necessary to efficiently manage human resource capacity. Job roles and skill profiles may be used to gauge an organizations ability to deliver new services or bid on new opportunities. For example, an organization may have the opportunity to bid on an information technology infrastructure contract that requires 200 java application programmers. The organization may only have 150 employees with a “java application programmer” job role but may have other employees that require minimal training to be a java application programmer. Skill profiles of each employee may be compared with a “java application programmer” job role to determine how much skill development is necessary to have fifty more employees satisfy the java application job role requirement and effectively plan capacity. Once an organization understands the amount of skill development required to offer a product or service, the organization may compare the cost of training against the profitability of the opportunity.

Additionally, the job role structure enables a just-in-time skill development mechanism for organizations to stay competitive in the industry. Job roles and skill profiles may be compared to determine which employees need to develop a new skill. For example, an organization may be in the java software business and may require each programmer to understand a new aspect of the java language, such as “Java Swing”. The new skill is added to a “Java programmer” job role. By comparing the Java programmer job role with skill profiles of employees assigned to Java programming, an organization may quickly determine which employees require new skill development.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram showing a job role structure applied in various business activities;

FIG. 2 is a diagram showing an employee with a corresponding job role that includes core skills and functional skills;

FIG. 3A is a diagram showing the difference in skills between an application programmer job role and a database administrator job role;

FIG. 3B is a diagram showing specific functional skill details between two application programmer job roles;

FIG. 4 is a diagram showing various job roles corresponding to a business's product or service offering;

FIG. 5 is a diagram showing job roles used for capacity planning;

FIG. 5 is a diagram showing the use of job roles to gauge an organizations ability to deliver a product or service;

FIG. 6 is a flowchart showing steps taken in capacity planning;

FIG. 7 is a diagram showing dynamic delivery of a new skill to an employee population;

FIG. 8 is a flowchart showing steps taken in deploying new skills to employees;

FIG. 9 shows a diagram using job roles to select an optimum employee match for new job role;

FIG. 10 is a flowchart showing steps taken in identifying and sending skill development options;

FIG. 11 is a diagram showing a skill map window that allows employees to customize skill development;

FIG. 12 is a diagram showing a manager and employees assessing skill development; and

FIG. 13 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

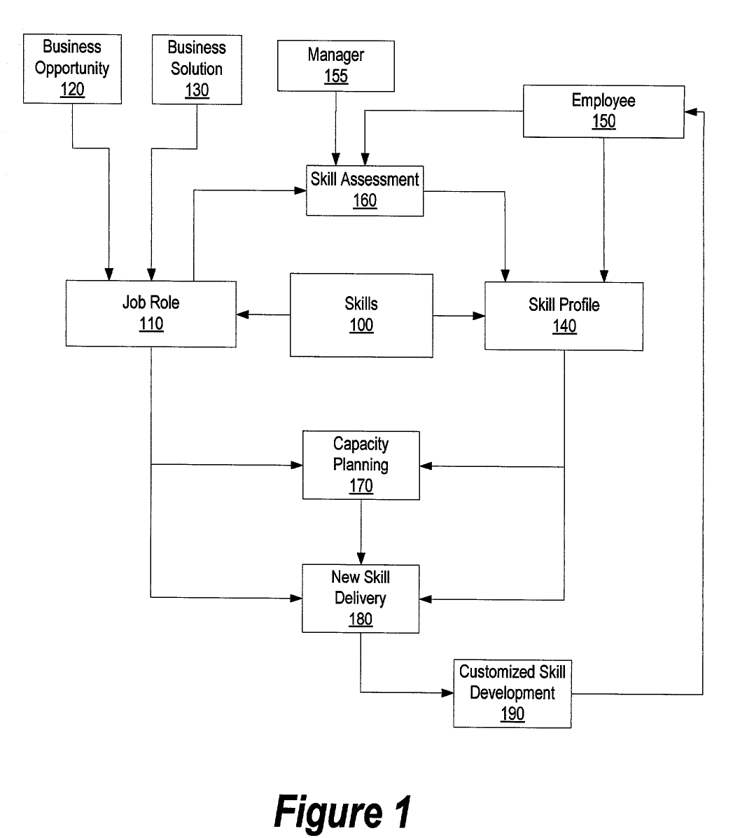

FIG. 1 is a block diagram showing a job role structure applied in various business activities. The job role structure and process provides companies with a way to predictably describe and understand capabilities needed to hire, develop, and manage human resources. A job role structure also defines professional services and consulting organizations' resources in terms of recognized market standards and nomenclature. For example, a business consultant in the banking industry requires a set of knowledge relating to banking systems, banking industry issues, and banking regulation to effectively serve his customers. Building the job role in terms of these standards and nomenclature provides a common, industry-wide means of defining employees and their skills.

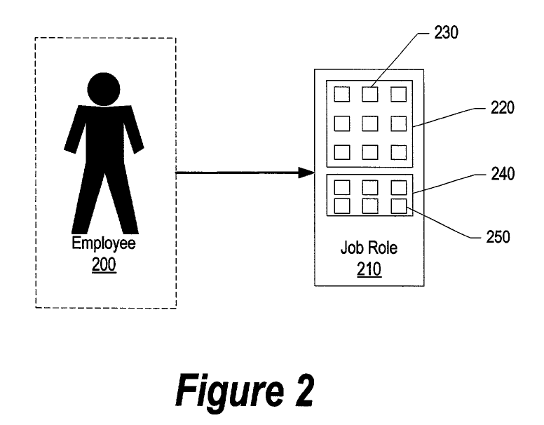

Skills 100 includes skills which may be segmented into two categories, core skills and functional skills. Core skills are profession specific skills and functional skills define a job role in more detail. For example, an information technology (IT) profession core skill may be “teamwork” and a functional skill may be “algorithm design” (see FIG. 2A for further detail regarding core skills and functional skills).

Job roles are defined (Job role 110) using skills 100 and input from business opportunity 120 and business solution 130. Business opportunity 120 includes existing business of an organization or opportunities that an organization is pursuing. Business solution 130 includes a product or service offering from an organization to satisfy business opportunity 120. For example, business opportunity 120 may be supplying personal computer parts and business solution 130 may be a computer hard drive.

Job role 110 includes core skills specific to a given profession and functional skills specific to business opportunity 120 and business solutions 130. Business opportunity 120 is analyzed to determine which functional skills are required for a given job role. For example, a business opportunity may be “supplying a java based software program” in which a functional skill for an application programmer job role may be “to be proficient at the java programming language.”

Business solution 130 is also analyzed to determine which functional skills are required for a given job role. Using the example described above, an organization may have an existing java software product in which a functional skill for a technical sales job role may be “to understand how the java software product works.”

Skill profile 140 incorporates skills 100 with employee 150's capabilities. Using the example described above, if an employee is proficient at java programming, then a java programming skill from skills 100 is included in the corresponding employee's skill profile.

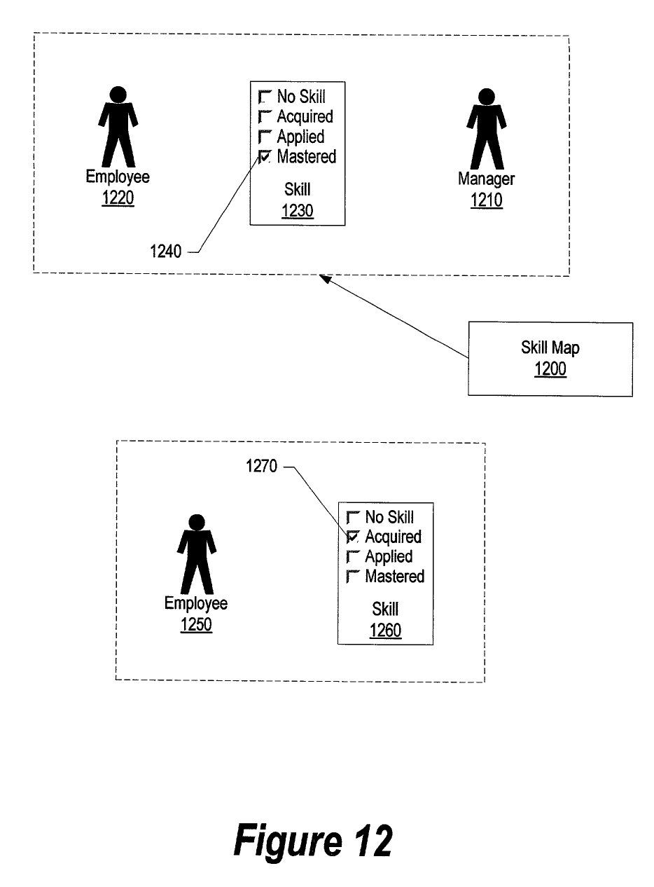

Skill profile 140 may include levels of proficiency for individual skills (i.e. acquired, applied, mastered, etc.). A skill assessment (skill assessment 160) may be conducted using employee 150's performance relative to a recent job assignment (job role 110). For example, an employee may finish a “java application programmer” assignment. The corresponding manager (manager 155) may assess employee 150's performance using the specified skills in a “java application programmer” job role. The resultant skill assessment is incorporated into employee 150's skill profile (skill profile 140). Using job roles for skill assessment allows immediate feedback in relevant areas (see FIG. 12 for further details regarding skill assessment).

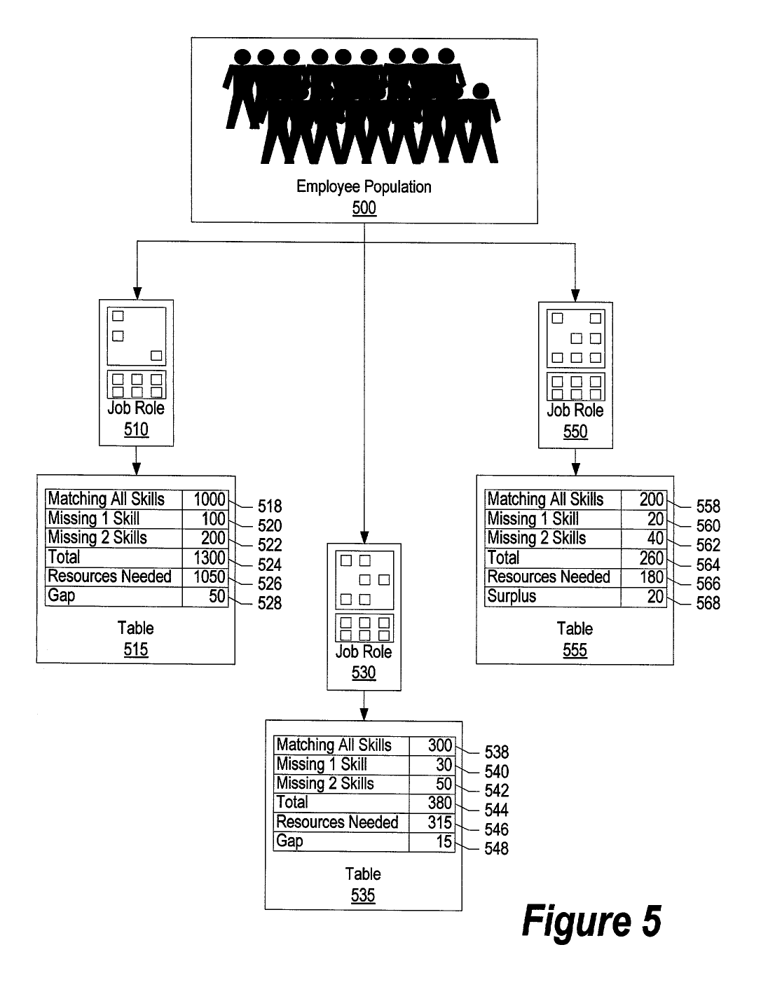

Job roles and skill profiles may be used to gauge an organizations ability to deliver new services or bid on new opportunities. For example, an organization may have the opportunity to bid on an information technology infrastructure contract that requires 200 java application programmers. The organization may only have 150 employees with a “java application programmer” job role but may have other employees that require minimal training to be a java application programmer. Skill profiles (skill profile 140) of each employee may be compared with a “java application programmer” job role (job role 110) to determine how much skill development is necessary to have fifty more employees satisfy the java application job role requirement and effectively plan capacity. (capacity planning 170) (see FIG. 5 for further details regarding capacity planning). Once an organization understands the amount of skill development required to offer a product or service, the organization may provide various ways for employees to develop the skills (new skill delivery 180).

Job roles and skill profiles may be used to determine which employees need to develop a new skill. For example, an organization may be in the java software business and may require each programmer to understand a new aspect of the java language, such as “Java Swing.” The new skill is added to the programmer job role (job role 110). Each programmer's skill profile (skill profile 140) is compared with “amended” job role 110 to determine which employees require new skill development (new skill delivery 180).

Some employee's may already have the new skill. Using the example described above, a programmer may have attended a “Java Swing” conference or read a Java Swing article to develop the Java Swing skill.

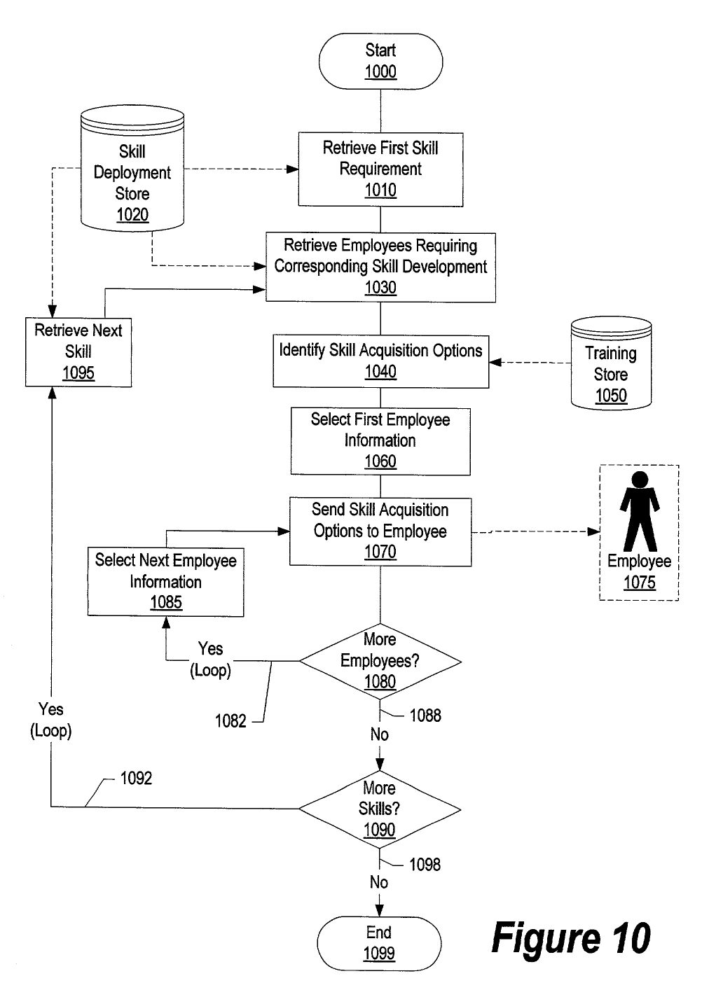

Employees that require new skill development are offered various ways in which to develop new skills. For example, an employee may frequently travel and may develop a skill more easily by reading a book instead of attending a three day seminar (customized skill development 190) (see FIG. 10 regarding new customized skill development).

Once the employee (employee 150) develops the new skill, his skill profile (skill profile 140) is updated to reflect his new capabilities.

FIG. 2 is a diagram showing an employee with a corresponding job role that includes core skills and functional skills. Job role 210 specifies skills required for employee 200 to effectively perform his existing job. Job role 210 includes two sections which are core skills 240 and functional skills 220.

Core skills 240 are general-purpose skills that employee 200 needs to effectively conduct business within a chosen profession. A profession defines a career path and the required core skills for competency in a chosen occupation. The profession sets a long-term path for an employee that may span an entire career. Professions are stable, externally recognizable, and transferable between different situations.

Core skills may be categorized into three areas which are business, leadership, and relationship. Employees in different professions may have similar core skills. However, specific core skills (core skill 250) may require more proficiency depending on the profession. For example, an application programmer and a salesperson may have a “customer relationship management” core skill since both employees may interact with customers. However, the salesperson should be more proficient at customer relationship management to perform his job effectively.

Functional skills 220 enable an employee to become specialized in a chosen profession. Functional skills have a narrower focus and may be acquired in a shorter time than core skills, better lending themselves to acquisition through focused education and mentoring programs. Using the example described above, functional skill 230 for an application programmer may be “algorithm design.”

Functional skills focus on specific products, technologies, industry issues, or company-specific processes and services. Their relevance may be of short time duration due to changing technology or business needs. Functional skills may be applicable to a specific company or a few companies within an industry.

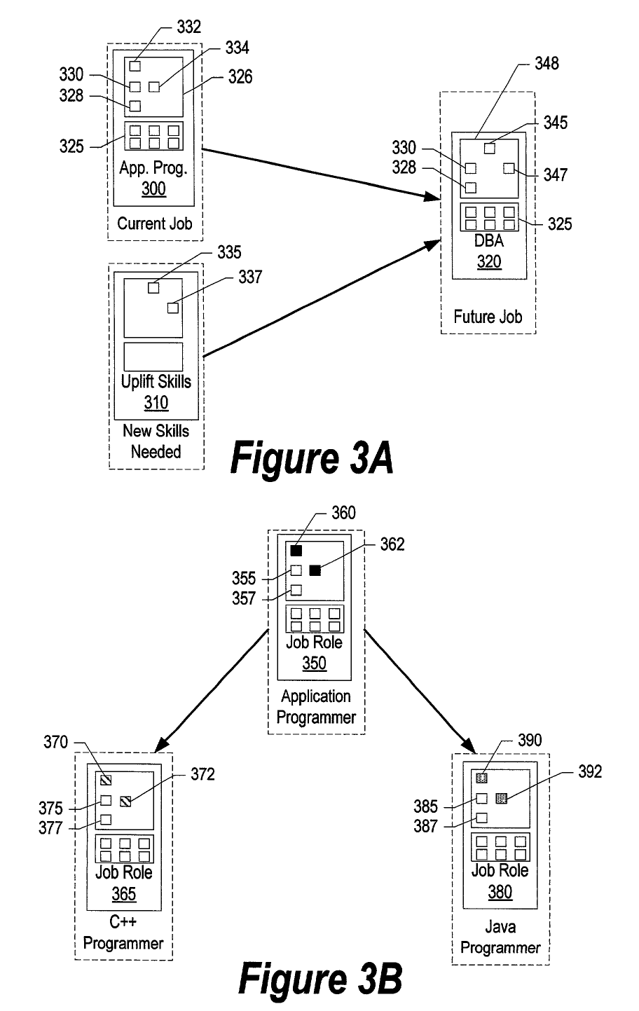

FIG. 3A is a diagram showing the difference in skills between an application programmer job role and a database administrator job role. Application programmer job role 300 includes core skills (325) and functional skills (326). Database Administrator (DBA) job role 320 includes core skills (325) and functional skills (348). Application programmer job role 300 and DBA job role 320 both include identical core skills 325 since core skills 325 are fundamental skills needed to be in the information technology specialist profession.

Functional skills enable specialization that may correspond to the type of industry, products, services, technologies, or processes. Application programmer job role 300 includes functional skills 326 which are general application programmer functional skills, such as “algorithm design.” Application programmer job role 300's functional skills are skill 328, skill 330, skill 332, and skill 334.

DBA job role 320 includes functional skills 348 which are general database administrator functional skills, such as “database management.” DBA 320's functional skills are skill 328, skill 330, skill 345, skill 347, and skill 348.

As can be seen, skill 328 and skill 330 are common between an application programmer and a database administrator. Skill 332 and skill 334 are unique to an application programmer. Skill 345 and skill 347 are unique to a database administrator.

Career planning is easily performed using structured job roles. If an application programmer strives to be a database administrator, the application programmer needs to develop skill 345 and skill 347. Skill 345 and skill 347 may be mapped into a concise job role format which identifies the required skills for an application programmer to become a DBA (uplift skills 310). Uplift skills 310 includes skill 335 and skill 337 which correspond to skill 345 and skill 347 respectively. An application programmer may review uplift skills 310 to identify which additional skills are required to be a database administrator.

FIG. 3B is a diagram showing specific functional skills between two application programmer job roles. Application programmer job role 350 shows a job role template for an application programmer. A template defines the internal structure and a general skill definition for a specified job role. Functional skills in application programmer job role 350 include two types, general skills (skill 355 and skill 357) and specialized skills (skill 360 and skill 362). For example a general skill for an application programmer may be “algorithm design” and a specialized skill may be based on a specific programming language, such as C++.

When a template is instantiated into an actual job role definition, such as a “Java application programmer” or a “C++ application programmer”, general skills are common between the two job roles. However, specialized skills may be different. C++ programmer job role 365 includes general skills 375 and 377 which correspond to skill 355 and skill 357. C++ programmer job role 365 also includes specialized skill 370 and skill 372 which are specific to the C++ programming language. For example, skill 370 may be “developing C++ data structures.”

Java programmer job role 380 includes general skills 385 and 387 which correspond to skill 355 and skill 357. Java programmer 380 also includes specialized skills 390 and 392 which are specific to the Java programming language. Specialized skills are more specific than general application development skills and focus on the particular job role.

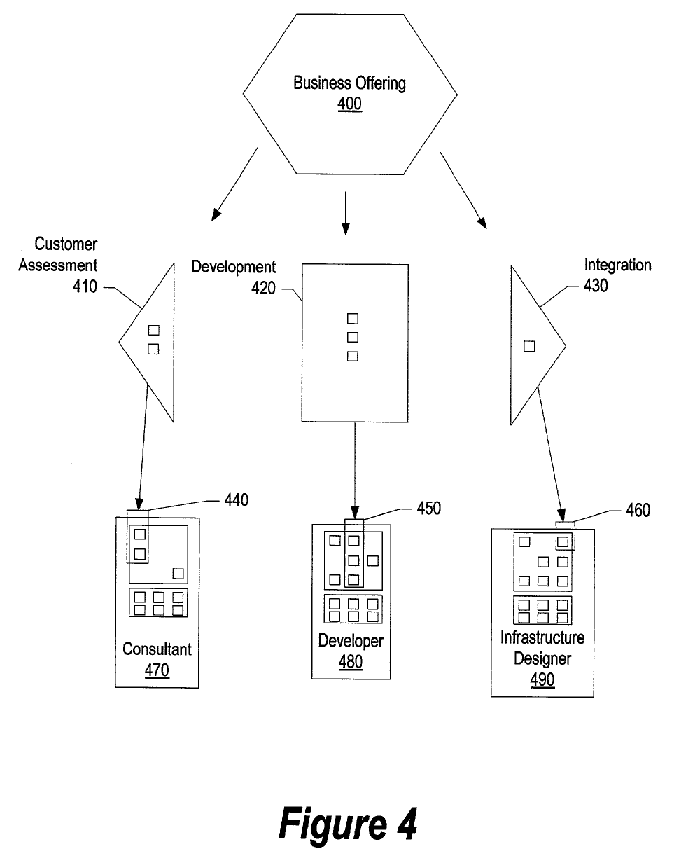

FIG. 4 is a diagram showing various job roles corresponding to a business's product or service offering. Job roles may be linked to an organization's product or service offering by specifying required skills based upon the product or service. Job roles provide organizations with a means to inventory employee skill profiles which may be used to understand, plan, and forecast the extent of the organization's ability to deliver and support its product or service offering.

Business offering 400 includes three services which are customer assessment 410, development 420, and integration 430. Customer assessment 410 may include understanding a customers' requirements and limitations. Development 420 may include developing a customized software program for the customer. Integration 430 may include integrating the developed software program into the customers' computer system.

Skills relating to customer assessment 410, development 420, and integration 430 are mapped into corresponding job roles. Consultant 470 includes skills 440 which correspond to the skills required to perform a customer assessment, such as “understanding customer requirements and limitations.” Developer 480 includes skills 450 which correspond to the skills required to develop a customized software program, such as “understand hash tables.” Infrastructure designer 490 includes skill 460 which correspond to the skill required to integrate software into a customers' computer system, such as “translating scripts.”

An organization has a means to understand, plan, and forecast its' ability to offer a product or service by determining the number of employees who have specific skills corresponding to the product or service offering (see FIG. 5 for further details regarding capacity planning analysis).

FIG. 5 is a diagram showing the use of job roles to gauge an organizations ability to deliver a product or service. The set of job roles required to deliver the product or service is compared with the skill profiles of employee population 500. Job role 510, job role 530, and job role 550 are job roles required to deliver a product or service. For example, an organization may offer customized software solutions and the job roles may be a developer, a consultant, and an infrastructure designer.

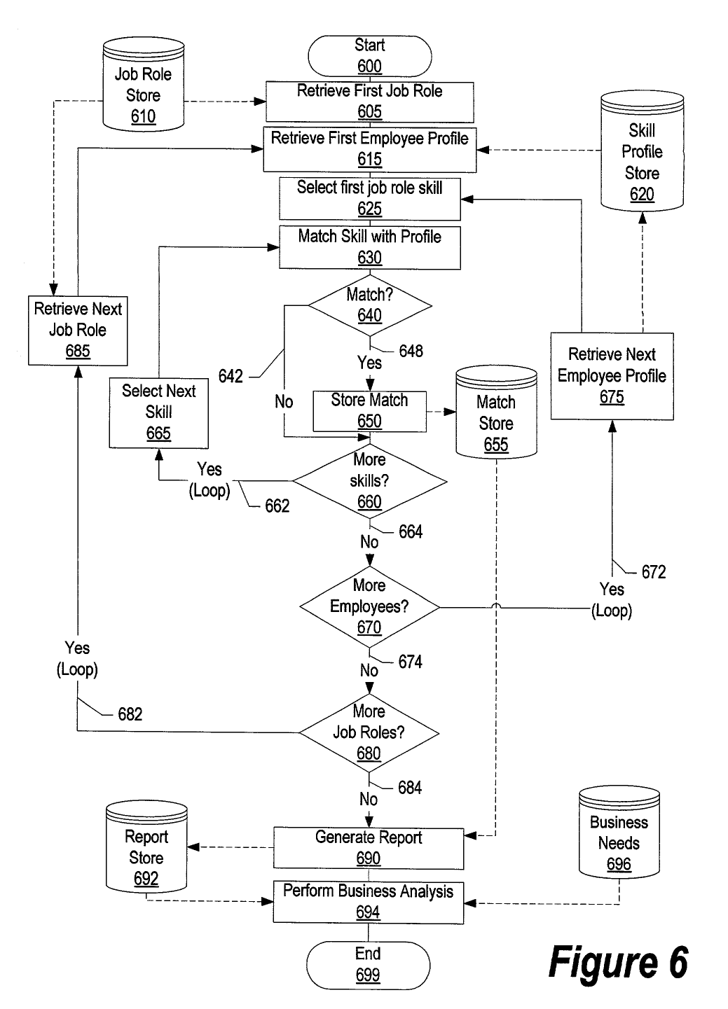

Employee skill profiles corresponding to employee population 500 are matched with job role skills included in job role 510 (see FIG. 6 for further details regarding skill matching). Using the example described above, job role 510 may be a “developer.” The matched results are included in table 515. Box 518 shows the number of employees that match each skill included in job role 510 (1,000 employees). In many cases, the number of employees that match each skill may not be sufficient to offer a product or service. In order to achieve a sufficient number of employees to offer a product or service, training may be required. Therefore, a comparison may be performed to determine the number of employees that match a number of the job role skills. Minimal training may then be performed with the employees that have the most job role skill matches.

Box 520 shows the number of employees that are missing one skill in job role 510 (100 employees). Box 522 shows the number of employees that are missing two skills in job role 510 (200 employees). Box 524 includes the total number of employee skill profiles compared to job role 510 (1,300 employees). Box 526 includes the number of resources required to meet job role 510 to offer the product or service (1,050 employees). Box 528 includes the gap or surplus of employees that match all job role skills (gap of 50 employees) relative to the number of resources needed in box 526. Using the example described above, the organization requires fifty more employees to obtain “developer” skills in order to support its' business opportunities.

In another embodiment, counting the number of employees that lack more than two skills in job role 510 may be required to obtain a sufficient number of employees to offer a product or service. An analysis may then be performed on the training costs of employees to determine if offering the product or service will be profitable.

Employee skill profiles corresponding to employee population 500 are matched with job role skills included in job role 530 (see FIG. 6 for further details regarding skill matching). Using the example described above, job role 530 may be a “consultant.” The matched results are included in table 535. Box 538 shows the number of employees that match each skill included in job role 530 (300 employees). In many cases, the number of employees that match each skill may not be sufficient to offer a product or service. In order to achieve a sufficient number of employees to offer a product or service, training may be required. Therefore, a comparison may be performed to determine the number of employees that match a number of the job role skills. Minimal training may then be performed with the employees that have the most job role skill matches.

Box 540 shows the number of employees that are missing one skill in job role 530 (30 employees). Box 542 shows the number of employees that are missing two skills in job role 530 (50 employees). Box 544 includes the total number of employee skill profiles compared to job role 530 (380 employees). Box 546 includes the number of resources required to meet job role 530 to offer the product or service (315 employees). Box 548 includes the gap or surplus of employees that match all job role skills (gap of 15 employees) relative to the number of resources needed in box 546. Using the example described above, the organization requires 15 more employees to obtain “consultant” skills in order to support its' business opportunities.

In another embodiment, counting the number of employees that lack more than two skills in job role 530 may be required to obtain a sufficient number of employees to offer a product or service. An analysis may then be performed on the training costs of employees to determine if offering the product or service will be profitable.

Employee skill profiles corresponding to employee population 500 are matched with job role skills included in job role 550 (see FIG. 6 for further details regarding skill matching). Using the example described above, job role 550 may be an “infrastructure designer.” The matched results are included in table 555. Box 558 shows the number of employees that match each skill included in job role 550 (200 employees). In many cases, the number of employees that match each skill may not be sufficient to offer a product or service. In order to achieve a sufficient number of employees to offer a product or service, training may be required. Therefore, a comparison may be performed to determine the number of employees that match a number of the job role skills. Minimal training may then be performed with the employees that have the most job role skill matches.

Box 560 shows the number of employees that are missing one skill in job role 550 (20 employees). Box 562 shows the number of employees that are missing two skills in job role 550 (40 employees). Box 564 includes the total number of employee skill profiles compared to job role 550 (260 employees). Box 566 includes the number of resources required to meet job role 550 to offer the product or service (180 employees). Box 568 includes the gap or surplus of employees that match all job role skills (surplus of 20 employees) relative to the number of resources needed in box 566. Using the example described above, the organization has a surplus of 20 infrastructure designers corresponding to the amount of its' business opportunities. The organization may decide to place the 20 infrastructure designers on existing projects to complete them more quickly or train the 20 infrastructure designers to be consultants or developers.

In another embodiment, counting the number of employees that lack more than two skills in job role 550 may be required to obtain a sufficient number of employees to offer a product or service. An analysis may then be performed on the training costs of employees to determine if offering the product or service will be profitable.

FIG. 6 is a flowchart showing steps taken in capacity planning. Processing commences at 600, whereupon a first job role is selected from job role store 610 (step 605). The job role may correspond to a business need, such as a business opportunity or a business solution. Job role store 610 may be stored in a non-volatile storage area, such as a computer hard drive. A first employee skill profile is retrieved from skill profile store 620 at step 615. The skill profile includes an employee's developed skills and may include a level of proficiency of the skill. For example, an employee may have mastered “algorithm design” in which an “algorithm design” skill is included in the employees' skill profile with a proficiency rating of “mastered.” Skill profile store 620 may be stored on a non-volatile storage area, such as a computer hard drive.

A first skill corresponding to the retrieved job role is selected at step 625. The first skill may be a core skill or a functional skill. If the job role core skills and the employee core skills (i.e. the same profession) are identical, core skill matching may be bypassed and processing may focus on functional skill matching.

The first job role skill is matched with the first employee's skill profile (step 630). The employee may be in a different job role than the job role under review, but may match the job role skill. For example, the job role under review may be a Java application programmer with a job role skill of “understanding Java programming language.” The employee under review may have a job role of “Java User Interface Designer” that also has a job role skill of “understanding Java programming language.” Another example is an employee may develop a skill independently of his job role. Using the example described above, a sales job role may not be required to have a skill of “understanding Java programming language” but a salesperson may have acquired the skill through books in order to perform his job more effectively.

A determination is made as to whether the employee has the first job role skill (decision 640). If the employee does not have the job role skill, decision 640 branches to “No” branch 642 bypassing store matching steps. On the other hand, if the employee has the job role skill under review, decision 640 branches to “Yes” branch 648 whereupon the skill match is stored corresponding to the employee skill profile in match store 655. Match store 655 may be stored in a non-volatile storage area, such as a computer hard drive.

A determination is made as to whether there are more skills to evaluate in the job role under investigation (decision 660). If there are more skills to evaluate, decision 660 branches to “Yes” branch 662 which loops back to select (step 665) and process the next skill. This looping continues until there are no more skills to evaluate, at which point decision 660 branches to “No” branch 664.

A determination is made as to whether there are more employee records to analyze for the job role under investigation (decision 670). If there are more employee skill profiles to analyze, decision 670 branches to “Yes” branch 672 which loops back to retrieve (step 675) and process the next employee record. This looping continues until there are no more employee records to analyze, at which point decision 670 branches to “No” branch 674.

A determination is made as to whether there are more job roles to investigate (decision 680). For example, an organization may want to expand its web page offering and want to analyze a graphic designer job role, a database administrator job role, and a programmer job role. Each job role and its corresponding job role skills are compared with the organization's employee skill profiles to determine if the organization has enough resources for each of the three job roles to expand its web page offering.

If there are more job roles to investigate, decision 680 branches to “Yes” branch 682 which loops back to retrieve (step 685) and process the next job role. This looping continues until there are no more job roles to investigate, at which point decision 680 branches to “No” branch 684. A report is generated at step 690 and stored in report store 692 that includes the number of employees that match each skill in the job roles investigated (step 690). The report may also provide detail as to how many employees are missing one or two skills in a particular job role. If multiple job roles were investigated, the report may include separate sections for each job role and how many employees matched each skill in the particular job role or the may highlight employees that match more than one job role. Employees who match more than one job role may be candidates for a project manager position.

A business analysis is performed at step 694 which compares a cost of providing training for a selected number of employees with an “opportunity increase.” The cost of providing training is determined by analyzing the additional training needed for a selected number of employees in report store 692. For example, employees may be selected that require training for a small number of skills (i.e. one or two skills).

The opportunity increase is determined by analyzing the organizations business needs in business needs store 696. For example, the opportunity increase may include increased revenue that an organization receives through business it may acquire by training the selected number of employees. Business needs store may be stored on a non-volatile storage area, such as a computer hard drive. Processing ends at 699.

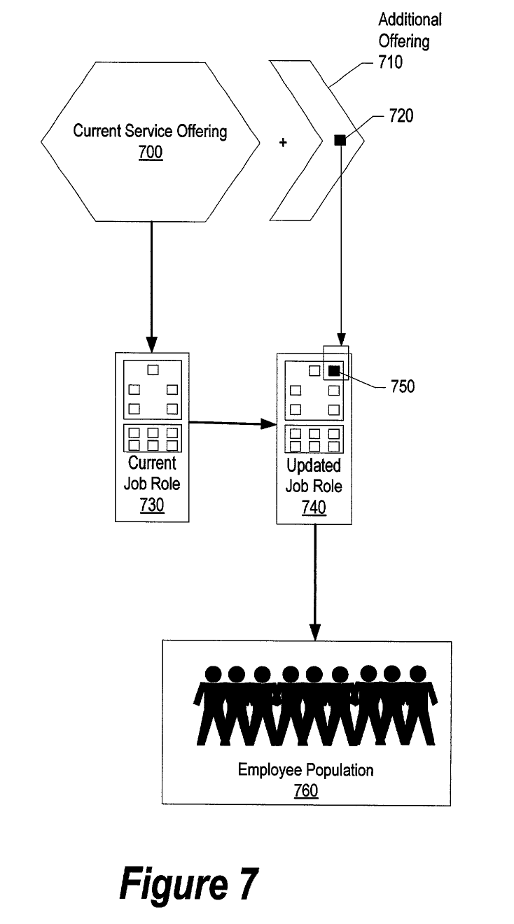

FIG. 7 is a diagram showing dynamic delivery of a new skill to an employee population. In many industries, the knowledge domain rapidly evolves and skills are constantly refreshed to remain competitive. The job role structure allows dynamic reconfiguration of job roles so businesses may quickly react to industry changes.

Current service offering 700 is supported by current job role 730. Additional offering 710 is added to current offering 700 to stay competitive within the industry. For example, current service offering 700 may be a web page offering supporting Java and added offering 710 may be an added service to support Java “Swing.” A skill corresponding to the new service is defined (skill 720). Using the example described above, skill 720 may be “understand Java Swing.”

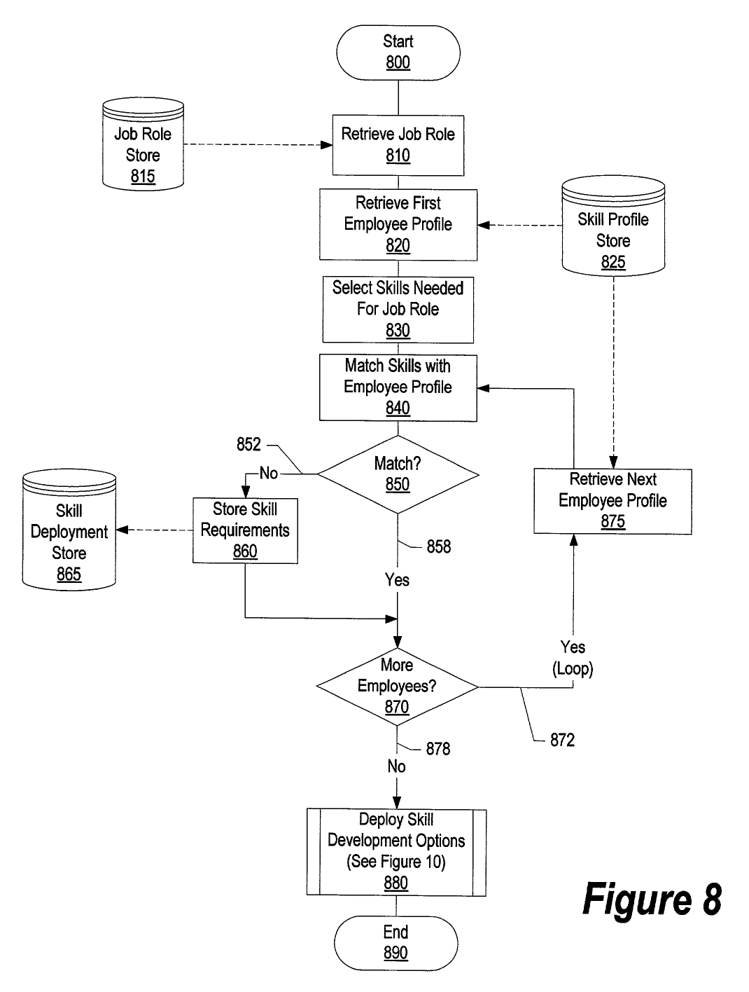

Updated job role 740 includes skills corresponding to current job role 730 and includes skill 750 which corresponds to skill 720. Skill 750 is deployed to employee population 760 that have current job role 730 (see FIG. 8 for further details regarding skill deployment). Some employees with the particular job role may already have the new skill. Using the example described above, some employees may be educated on Java Swing by attending a seminar or reading a book.

FIG. 8 is a flowchart showing steps taken in deploying new skills to employees. Processing commences at 800, whereupon a job role is retrieved from job role store 815 (step 810). The job role may be a job role that has a newly defined skill. For example, the job role may be a java application programmer job role and the newly defined skill may be “understand Java Swing.” Job role store 815 may be stored on a non-volatile storage area, such as a computer hard drive. A first employee skill profile is retrieved from skill profile store 825 at step 820. Skill profile store 825 may be stored on a non-volatile storage area, such as a computer hard drive. The employee skill profile includes skills acquired by an employee and may include a level of proficiency corresponding to each skill.

The skills corresponding to the job role are selected at step 830 and matched with the employee skill profile at step 840. The selected skills may be all skills in the job role or a subset of the skills, such as newly defined skills. A determination is made as to whether the employee has developed each job role skill (decision 850). If the employee has developed each job role skill, decision 850 branches to “Yes” branch 858 bypassing skill requirement storing steps. On the other hand, if the employee has not developed each job role skill, decision 850 branches to “No” branch 852 whereupon a requisite for the employee to develop the unmatched skills is stored in skill deployment store 865 (step 860).

In another embodiment, a determination may be made as to the proficiency level of the employee compared with the required proficiency level of the new skill. For example, if the job role under analysis is project manager and the new skill is to understand a spreadsheet program, the project manager may have to know how to enter data but not be required to write macro programs.

A determination is made as to whether there are more employees with the job role under analysis (decision 870). If there are more employees with the job role under analysis, decision 870 branches to “Yes” branch 872 which loops back to retrieve (step 875) and process the next employee profile. This looping continues until there are no more employees with the job role under analysis, at which point decision 870 branches to “No” branch 878 whereupon skill development options are deployed (pre-defined process block 880, see FIG. 10 for further details). Processing ends at 890.

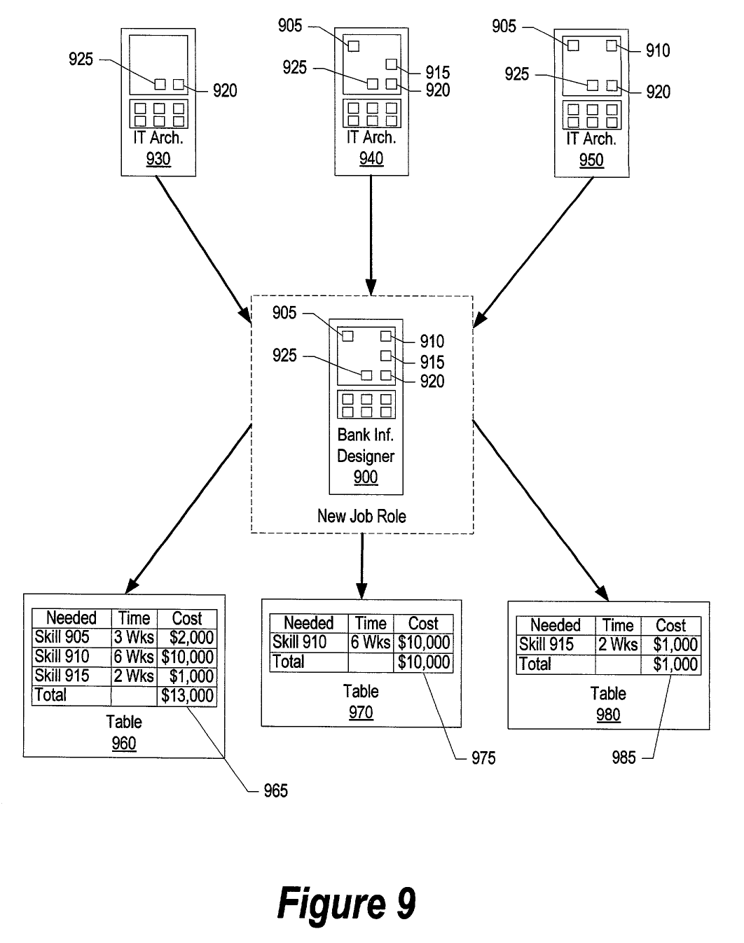

FIG. 9 shows a diagram using job roles to select an optimum employee match for new job role. An organization develops bank infrastructure designer job role 900 to support a new opportunity. Bank infrastructure designer job role 900 requires skill 905, skill 910, skill 915, skill 920, and skill 925. The organization may not have banking infrastructure designers but determines that an information technology (IT) architect job role is similar to a banking infrastructure designer job role.

The organization compares three IT architect's employee skill profiles (IT Architect 930, IT Architect 940, and IT Architect 950) with job role 900. IT Architect 930 has skill 920 and skill 925 but needs skill 905, skill 910, and skill 915 in order to meet the new job role. IT Architect 940 has skill 905, skill 915, skill 920, and 925 but needs skill 910 in order to meet the new job role. IT Architect 950 has skill 905, skill 910, skill 920, and skill 925 but needs skill 915 in order to meet the new job role.

An analysis is performed to determine which employee is best suited to become a banking infrastructure designer. Table 960 shows the cost and time for IT Architect 930 to obtain the skills needed to meet the new job role requirements. Skill 905 costs $2,000 and takes three weeks to complete. Skill 910 costs $10,000 and takes six weeks to complete. Skill 915 costs $1,000 and takes two weeks to complete. Therefore, it costs $13,000 (box 965) for IT Architect 930 to meet the new job role requirement.

Table 970 shows the cost and time for IT Architect 940 to obtain the skills needed to meet the new job role requirement. Skill 910 costs $10,000 and takes six weeks to complete. Therefore, it costs $10,000 (box 975) for IT Architect 940 to obtain the skills needed for him to meet the new job role.

Table 980 shows the cost and time for IT Architect 950 to obtain the skill needed to meet the new job role requirement. Skill 915 costs $1,000 and takes two weeks to complete. Therefore, it takes $1,000 (box 985) for IT Architect 950 to obtain the skills needed to meet the new job role requirement.

The organization reviews the total cost for each employee to obtain the skills needed to meet the new job role requirements and determines which IT architect is best suited for the new job role. In this embodiment, employee 950 is best suited for the new job role since it costs the least amount of money and takes the least amount of time for employee 950 to obtain the skills required to meet the new job role.

FIG. 10 is a flowchart showing steps taken in identifying and sending skill development options. Processing commences at 1000, whereupon a first skill requirement is retrieved from skill deployment store 1020 (step 1010). Skill deployment store 1020 may be stored on a non-volatile storage area, such as a computer hard drive. Information is retrieved regarding each employee required to acquire the first skill from skill deployment store 1020 at step 1030. Employee information may be an employee identifier, such as a social security number or employee id number.

Training information is retrieved from training store 1050 and skill acquisition options are identified (step 1040). Training store 1050 may be stored on a non-volatile storage area, such as a computer hard drive. Training store 1050 may include information corresponding to skill development, such as class offerings, mentor programs, articles, and books.

Skill acquisition options may include an in-house class offering. An in-house class offering may be determined by analyzing the number of employees required to develop the skill, and determine whether it is less expensive to have an in-house class offering or have employees attend class offsite.

Information corresponding to a first employee required to acquire the skill is selected at step 1060. The employee information may be an email address or an office mail box number. The skill acquisition options are sent to employee 1075 at step 1070. A determination is made as to whether there are more employees required to develop the first skill (decision 1080). If there are more employees to develop the first skill, decision 1080 branches to “Yes” branch 1082 which loops back to select (step 1085) and process the next employee information. This looping continues until there are no more employees required to develop the first skill, at which point decision 1080 branches to “No” branch 1088.

A determination is made as to whether there are more skills to develop (step 1090). For example, management may want to focus on web page development opportunities in which multiple new skills may be required to stay competitive in the industry. If there are more skills to develop, decision 1090 branches to “Yes” branch 1092 which loops back to retrieve (step 1095) and process the next skill. This looping continues until there are no more skills to develop, at which point decision 1090 branches to “No” branch 1098. Processing ends at 1099.

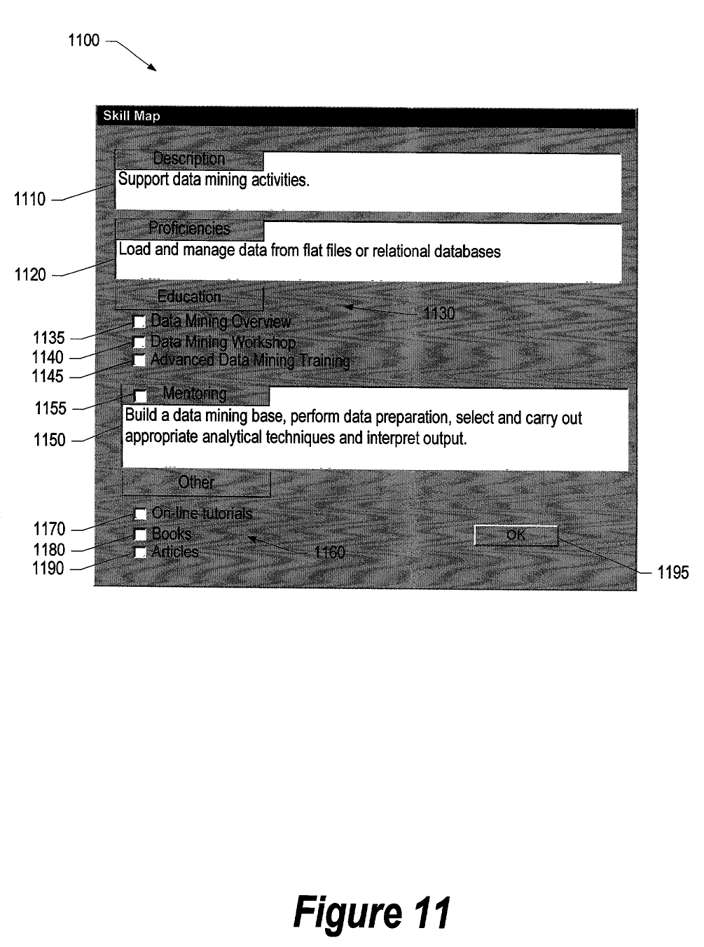

FIG. 11 is a diagram showing a skill map window that allows employees to customize skill development. Skill maps allow employees to take a non-traditional approach to skill development. Employees may have multiple ways to develop a skill instead of being limited in their ability to develop the skill. For example, it may be difficult for an employee who travels frequently to attend a three-day seminar for skill development. It may be simpler for the employee to read a book or participate in an online class to develop the skill.

Skill map window 1100 includes five main areas which are description 1110, proficiencies 1120, education 1130, mentoring 1150, and other 1160. Description 1110 describes the skill to be developed, such as “support data mining activities.” Proficiencies 1120 includes a list of what an employee should be proficient, such as “load and manage data from flat files or relational databases.” Proficiencies 1120 may be used for skill assessment and to track skill acquisition progress (see FIG. 12 for further details regarding skill assessment).

Ways to obtain proficiency of a particular skill are included in education 1130, mentoring 1150, and other 1160. An employee may choose to take a class to develop the skill. The employee selects box 1135 if he chooses to register for “data mining overview.” The employee selects box 1140 if he chooses to register for “data mining workshop.” The employee selects box 1145 if he chooses to register for “advanced data mining training.” A registration window is displayed corresponding to the employee's selection. In another embodiment, a web-based hypertext format may be used for skill map windows and registration windows.

The education section may be configured to only show courses in a geographic area. For example, if an employee works in a metropolitan area, the employee may configure the skill map to only show available courses in the same metropolitan area. If an employee has already taken a class that is displayed, the class may be “grayed out” indicating that the employee has already taken the class.

Mentoring 1150 includes information about a mentoring program the employee has the option of participating. The mentoring program may include a list of objectives, such as “build a data mining base, perform data preparation, select and carry out appropriate analytical techniques and interpret output.” The employee selects box 1155 to participate in the corresponding mentoring program. A mentor program window may be displayed for the employee to register when the employee selects box 1155.

Other 1160 includes other methods for an employee to acquire a skill. The employee may choose on-line tutorials (box 1170), books (box 1180), or articles (box 1190) to assist in skill development. Windows may be displayed providing more information corresponding to the employee's selection.

When the employee is finished customizing his skill development, the employee selects button 1195 to save his changes and close the skill map window.

FIG. 12 is a diagram showing a manager and employees assessing skill development. Skill assessments may be performed regularly, such as quarterly, or skill assessments may be performed after an employee has completed a project in which the skill assessment is focused on the skills corresponding to the job role the employee was assigned.

For example, an employee may have a C++ programmer job role for a project. When the project completes, the employee is assessed on skills required for a C++ job role. The employee may not be assessed on other skills, such as Java programming. The employee may perform a self-assessment or his manager may be involved during the assessment.

Employee 1220 has registered and taken several classes in response to receiving skill map 1200 (see FIG. 11 for further details regarding skill maps). Skill map 1220 includes new skills required for employee 1220's job role. Employee 1220 converses with manager 1210 to determine the employees' proficiency level regarding skill 1230 after taking classes. Employee 1220 and manager 1210 determine that employee 1220 has mastered skill 1230 and selects box 1240 corresponding to their decision.

In one embodiment, employee titles may be determined based on their skill assessment. For example, employees that have an “acquired” or “applied” skill level may be considered junior programmers. Whereas employees that have a “mastered” skill level may be considered senior programmers.

Employee 1250 is ending a job assignment in which she had a job role that included skill 1260. Employee 1250 performs a self-assessment of skill 1260 and determines that her proficiency at skill 1260 is “acquired” and selects box 1270. Employee 1250 may decide that she wants more training to achieve an “applied” skill level and may research online training programs or articles to make her more proficient at skill 1260.

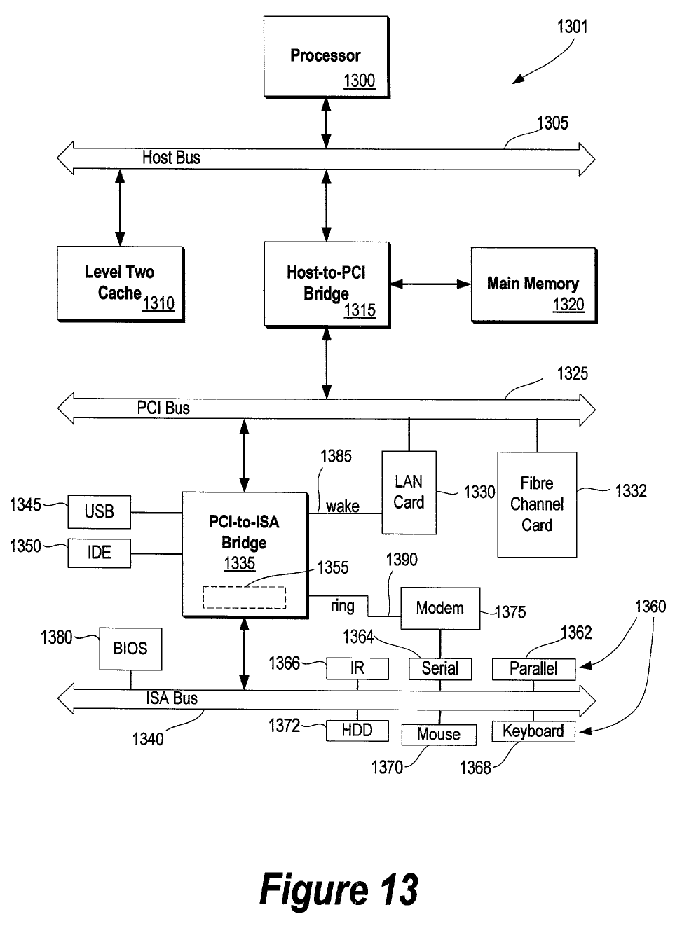

FIG. 13 illustrates information handling system 1301 which is a simplified example of a computer system capable of performing the server and client operations described herein. Computer system 1301 includes processor 1300 which is coupled to host bus 1305. A level two (L2) cache memory 1310 is also coupled to the host bus 1305. Host-to-PCI bridge 1315 is coupled to main memory 1320, includes cache memory and main memory control functions, and provides bus control to handle transfers among PCI bus 1325, processor 1300, L2 cache 1310, main memory 1320, and host bus 1305. PCI bus 1325 provides an interface for a variety of devices including, for example, LAN card 1330. PCI-to-ISA bridge 1335 provides bus control to handle transfers between PCI bus 1325 and ISA bus 1340, universal serial bus (USB) functionality 1345, IDE device functionality 1350, power management functionality 1355, and can include other functional elements not shown, such as a real-time clock (RTC), DMA control, interrupt support, and system management bus support. Peripheral devices and input/output (I/O) devices can be attached to various interfaces 1360 (e.g., parallel interface 1362, serial interface 1364, infrared (IR) interface 1366, keyboard interface 1368, mouse interface 1370, and fixed disk (HDD) 1372) coupled to ISA bus 1340. Alternatively, many I/O devices can be accommodated by a super I/O controller (not shown) attached to ISA bus 1340.

BIOS 1380 is coupled to ISA bus 1340, and incorporates the necessary processor executable code for a variety of low-level system functions and system boot functions. BIOS 1380 can be stored in any computer readable medium, including magnetic storage media, optical storage media, flash memory, random access memory, read only memory, and communications media conveying signals encoding the instructions (e.g., signals from a network). In order to attach computer system 1301 to another computer system to copy files over a network, LAN card 1330 is coupled to PCI bus 1325 and to PCI-to-ISA bridge 1335. Similarly, to connect computer system 1301 to an ISP to connect to the Internet using a telephone line connection, modem 1375 is connected to serial port 1364 and PCI-to-ISA Bridge 1335.

While the computer system described in FIG. 13 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for managing employee development, said method comprising:
identifying one or more job skills for each of a plurality of employees;
comparing one or more business needs with the identified employee job skills;
determining an amount of additional job skills needed for each of the employees based on the comparing;
selecting one or more of the employees based upon the amount of additional job skills needed for each of the employees; and
creating a business analysis based upon the amount of additional job skills needed for the selected employees.

2. The method as described in claim 1 wherein the business needs are selected from the group consisting of a business opportunity and a business solution.

3. The method as described in claim 1 further comprising:
defining a job role based upon one or more of the business needs, the job role including one or more of the job skills wherein the job skills include core skills and functional skills.

4. The method as described in claim 1 further comprising:
providing training to one or more of the selected employees corresponding to the additional job skills needed.

5. The method as described in claim 4 further comprising:
matching the additional job skills needed with one or more skill acquisition options;
displaying the skill acquisition options;
receiving a selection wherein the selection corresponds to one or more skill acquisition options; and
enrolling in a skill development activity corresponding to the selection.

6. The method as described in claim 1 wherein the business analysis further comprises:
determining a training costs associated with the additional job skills needed for one or more of the selected employees;
quantifying an opportunity increase based upon one or more of the selected employees acquiring the additional skills needed; and
calculating a cost benefit analysis by comparing the training cost with the opportunity increase.

7. The method as described in claim 6 further comprising:
providing training to one or more of the selected employees based upon the calculation.

8. An information handling system comprising:
one or more processors;
a memory accessible by the processors;
one or more nonvolatile storage devices accessible by the processors;
an employee development tool for training employees, the employee development tool including:
means for identifying one or more job skills for each of a plurality of employees;
means for comparing one or more business needs with the identified employee job skills;
means for determining an amount of additional job skills needed for each of the employees based on the comparing;
means for selecting one or more of the employees based upon the amount of additional job skills needed for each of the employees; and
means for creating a business analysis based upon the amount of additional job skills needed for the selected employees.

9. The information handling system as described in claim 8 wherein the business needs are selected from the group consisting of a business opportunity and a business solution.

10. The information handling system as described in claim 8 further comprising:
means for defining a job role based upon one or more of the business needs, the job role including one or more of the job skills wherein the job skills include core skills and functional skills.

11. The information handling system as described in claim 8 further comprising:
means for providing training to one or more of the selected employees corresponding to the additional job skills needed.

12. The information handling system as described in claim 11 further comprising:
means for matching the additional job skills needed with one or more skill acquisition options;
means for displaying the skill acquisition options;
means for receiving a selection wherein the selection corresponds to one or more skill acquisition options; and
means for enrolling in a skill development activity corresponding to the selection.

13. The information handling system as described in claim 8 wherein the business analysis further comprises:
means for determining a training costs associated with the additional job skills needed for one or more of the selected employees;
means for quantifying an opportunity increase based upon one or more of the selected employees acquiring the additional skills needed; and
means for calculating a cost benefit analysis by comparing the training cost with the opportunity increase.

14. A computer program product stored in a computer operable media for employee development, said computer program product comprising:
means for identifying one or more job skills for each of a plurality of employees;
means for comparing one or more business needs with the identified employee job skills;
means for determining an amount of additional job skills needed for each of the employees based on the comparing;
means for selecting one or more of the employees based upon the amount of additional job skills needed for each of the employees; and
means for creating a business analysis based upon the amount of additional job skills needed for the selected employees.

15. The computer program product as described in claim 14 wherein the business needs are selected from the group consisting of a business opportunity and a business solution.

16. The computer program product as described in claim 14 further comprising:
means for defining a job role based upon one or more of the business needs, the job role including one or more of the job skills wherein the job skills include core skills and functional skills.

17. The computer program product as described in claim 14 further comprising:
means for providing training to one or more of the selected employees corresponding to the additional job skills needed.

18. The computer program product as described in claim 17 further comprising:
means for matching the additional job skills needed with one or more skill acquisition options;
means for displaying the skill acquisition options;
means for receiving a selection wherein the selection corresponds to one or more skill acquisition options; and
means for enrolling in a skill development activity corresponding to the selection.

19. The computer program product as described in claim 14 wherein the business analysis further comprises:
means for determining a training costs associated with the additional job skills needed for one or more of the selected employees;
means for quantifying an opportunity increase based upon one or more of the selected employees acquiring the additional skills needed; and
means for calculating a cost benefit analysis by comparing the training cost with the opportunity increase.

20. The computer program product as described in claim 19 further comprising:
means for providing training to one or more of the selected employees based upon the calculation.
